(19) United States
(12) Patent Application Publication
(10) Pub. No.: US 2011/0252649 A1
(43) Pub. Date: Oct. 20, 2011

(54) Sheath-cord combination, kit, and method of manufacture

(76) Inventor: John Lovitz, Wauconda, IL (US)

(21) Appl. No.: 12/799,135

(22) Filed: Apr. 19, 2010

(51) Int. Cl. B26B 29/02; B23P 11/00; B26B 3/06

(52) U.S. Cl. 30/162; 224/232; 224/5; 30/298.4; 29/428

(57) ABSTRACT

A sheath-cord assembly, kit, and method for manufacturing same provides users with a blade-protecting sheath and a braided or weaved length of cord fastened thereto. The sheath portion defines a blade-receiving inner pocket and comprises at least one aperture structure extending therethrough adjacent the pocket. The length of cord is preferably braided to provide both a decorative effect and an ample cord source when attached to the sheath portion. The cord preferably comprises thermally-liquefiable material and has opposed primary cord ends, which ends are insertable through the aperture structure and are thermally-liquefiable for respectively liquefying the primary cord ends at the aperture structure. The liquefied primary cord ends are thermally-solidifiable for fastening the primary cord ends to the sheath assembly at the aperture structure.

### BACKGROUND OF THE INVENTION

1. Field of the Invention

The present invention generally relates to a sheath assembly, and more particularly, to a sheath-cord combination for providing users with a decorative length of cord readily available and wearable upon the user's sheath.

2. Description of Prior Art

U.S. Pat. No. 2,117,937 ('937 patent), which issued to Brownell, discloses a Knife Sheath. The '937 patent describes a sheath like body providing a pocket for the blade of a knife, a tongue formed on the body and rising therefrom, said tongue on the body and rising therefrom, said tongue having spaced parallel slots extending longitudinally therein, means including a loop extending through the slots for adjustment with respect to the tongue for receiving and gripping the handle of the knife, and a substantially arrowhead shaped flap formed on the means and having spaced parallel slots therein to receive the belt of the wearer of the sheath for slidably securing the flap to the belt, and means for detachably securing the flap to the tongue.

U.S. Pat. No. 4,803,745 ('745 patent), which issued to Izquierdo, discloses a Survival Knife Sheath. The '745 patent describes a knife sheath including a rear side defining an upwardly opening receptacle portion for downwardly receiving therein the blade of a survival knife and a front side defining a pair of side-by-side upwardly opening compartments with one of the compartments having a plurality of aerial flares stored therein and the other compartment defining an aerial flare supporting compartment in which the base end of one of the aerial flares may be removably retentatively supported.

The knife sheath of the '745 patent further defines a firing pin bore disposed immediately beneath and opening upward into the aforementioned other compartment and containing an upwardly spring biased firing pin therein for impact with a center primer portion of the base end of aerial flare retained in position thereabove. The sheath also includes an exteriorly slidably mounted trigger member operably connected to firing pin through a slot formed in the sheath and upon which downward manual digital pressure may be applied to downwardly retract the firing pin from an associated aerial flare for subsequent release and impact engagement with the flare primer.

U.S. Pat. No. 4,805,818 ('818 patent), which issued to Harrison, discloses a Knife Sheath and Tool Device. The '818 patent describes a knife sheath device comprising a gripping or cutting type of tool such as a pair of pliers or wire cutters. The device includes a sheath pivotally mounted upon a back plate with the back plate and sheath cooperating to form and operate the tool. Portions of the tool are formed or attached to the sheath and also to the back plate, and the tool is operated by pivoting the sheath in relation to the back plate.

U.S. Pat. No. 4,805,819 ('819 patent), which issued to Collins, discloses a Sheath for a Retractable Knife. The '819 patent describe a sheath for housing a retractable knife both in its retracted or unretracted state provided with a pair of pockets, one adapted to receive the knife blade and a second adapted to receive the knife when the blade is housed within its handle, and additionally capable of being folded into a more compact form when housing a retracted knife.

U.S. Pat. No. 5,009,348 ('348 patent), which issued to Derkatz, discloses a Knife Sheath of Tough Flexible Material. The '348 patent describes a knife sheath comprising a back wall, a front wall attached at its periphery to said back wall to form a knife-receiving pouch, and a pair of laterally spaced slits in said front wall for receiving a wearer's belt, said slits being offset in the longitudinal direction, whereby when the wearer's belt is passed through said offset slits said pouch sits at a forward angle on the wearer's belt and snugly located on the wearer's hip and tucked in the belt.

U.S. Pat. No. 6,840,416, ('416 patent), which issued to Aberman, describes a Knife Sheath. The '416 patent describes a sheath for carrying a knife or blade comprising a scabbard attached to a carrying strap forming a loop through which a carrying junction such as a belt may be passed. The axis of the loop is generally aligned with a transverse axis perpendicular to an axis of gravity. The length of the scabbard includes a longitudinal axis generally angled with respect to the axis of gravity. The mouth of the scabbard is further angled with regard to the transverse axis. Each of the foregoing alignments allows a user to more easily and efficiently insert and remove a blade into the scabbard while carrying the sheath. The sheath is also provided with an inner shell disposed inside the scabbard, the inner shell having a plurality of lengthwise linear ridges for gripping the blade inside the shell.

United States Patent Application No. 2008/0250652, which was authored by Fellhoelter, describes a knife and sheath that includes a spring element as part of the handle with a pin that engages a slot in the sheath so as to lock the knife and sheath together. The knife and sheath are unlocked by biasing the spring element towards the center line of the knife, thereby disengaging the pin from the slot.

To those with extensive experience in outdoor and primitive camping scenarios, it should become apparent that there are situations that invariably arise in which one requires or could greatly benefit from additional cordage, but which cordage is not readily available with the supplies on hand. As a sheathed knife is normally carried in such situations, it becomes apparent that the extra cordage could be attached to the sheath, thus having cordage available whenever the need arises.

After exhaustive development, it was found that weaving or braiding a cord and attaching it to a sheath via apertures formed in the sheath afforded several additional feet of cordage with no interference to the knife or sheath. This additional cordage was invaluable for situations in which tent or tarp cords need to be replaced, emergency fishing line is needed (e.g. the cordage exemplified in this application comprise thinner strands which can be separated for this purpose), clothesline for drying, tying lean to shelters, and securing gear, for example.

It will be seen from an inspection of the prior art juxtaposed adjacent the foregoing conceptual bases that the prior art perceives a need for a sheath-cord combination for providing users with a readily available source of cord, easily carried and ornamentally or decoratively applied to a blade sheath.

### SUMMARY OF THE INVENTION

Accordingly, it is a primary object of the present invention to provide certain means for carrying additional cordage attached to a knife sheath in a compact and easily accessible manner. The purpose of the additional cordage being attached to the sheathing allows the carrier to have approximately 8.5 feet (on a 7 inch sheath) of cordage available for both emergency and non-emergency situations. The unique weaving-braiding process of the cordage allows for various lengths of cordage based on the sheath size being used.

To achieve these and other readily apparent objectives, the present invention essentially provides a sheath-cord assembly, kit, and method for manufacturing same such that users thereof are provided a blade-protecting sheath and a readily accessible length of cord. The sheath-cord combination according to the present invention thus comprises, in combination a sheath assembly and a (braided) length of cord. The sheath assembly has forward and rearward sheath portions, which forward and rearward sheath portions define a blade-receiving inner pocket and comprise at least one aperture structure extending therethrough adjacent a pocket periphery.

The length of cord preferably comprises thermally-liquefiable material and has opposed primary cord ends, which primary cord ends are insertable through the aperture structure and are thermally-liquefiable for respectively liquefying the primary cord ends at the aperture structure. The liquefied primary cord ends are thermally-solidifiable for fastening or anchoring the primary cord ends to the sheath assembly at the aperture structure. The sheath-cord assembly thus provides users with a blade-protecting sheath and an end-fastened length of cord.

### BRIEF DESCRIPTION OF THE DRAWINGS

Other features of my invention will become more evident from a consideration of the following brief description of patent drawings:

FIG. 1 is a depiction of three cords, two of which cords are coiled at the lower end thereof and oppose a folded or undulated central cord.

FIG. 2 is a depiction of a braided cord assembly with parts broken away to show an inner folded cord structure according to the present invention.

FIG. 3 is a depiction of a braided cord assembly according to the present invention.

FIG. 4 is a plan view of a knife sheath showing an internal knife-receiving pocket as depicted with broken lines.

FIG. 5 is a front plan view of a first sheath-cord combination according to the present invention showing a sheath with braided cord attached thereto.

FIG. 5(a) is an enlarged, fragmentary sectional view of a front side to a cord-to-sheath junction site showing two cord strands inserted through a sheath aperture, one of which is wrapped about the sheath periphery.

FIG. 6 is a front plan view of a second sheath-cord combination according to the present invention showing a sheath with braided cord attached thereto.

FIG. 7 is a back plan view of the second sheath-cord combination according to the present invention depicting a first cord attaching arrangement with heat or thermal energy being directed into cord ends to heat-melt or thermally liquefy the cord ends at aperture structures thereof.

FIG. 7(a) is an enlarged, fragmentary sectional view of a back side to a cord-to-sheath junction site showing two cord strands inserted through a sheath aperture, one of which is wrapped about the sheath periphery and one of which is being heat melted or thermally liquefied.

FIG. 7(b) is an enlarged, fragmentary sectional view of a back side to a cord-to-sheath junction site showing two cord strands inserted through a sheath aperture, one of which is wrapped about the sheath periphery and one of which has been heat melted or thermally liquefied and thermally solidified, the latter of which has parts broken away to depict otherwise hidden structure.

FIG. 8 is a back plan view of the second sheath-cord combination according to the present invention depicting a second cord attaching arrangement with heat being directed into cord ends to heat-melt the cord ends to the sheath at aperture structures thereof.

FIG. 8(a) is an enlarged, fragmentary sectional edge view of a cord-to-sheath junction site showing a cord strand inserted through a sheath aperture and having been thermally liquefied with thermal energy being directed out of the liquefied material for solidifying the liquefied material at the cord end and anchoring the cord end to the sheath.

FIG. 9 is a top perspective view of a sheath-cord kit according to the present invention showing a braided cord, a sheath, and a bladed element in packaging.

### DETAILED DESCRIPTION OF THE PREFERRED EMBODIMENT

Referring now to the drawings with more specificity, the present invention essentially provides a sheath-cord combination 10 or utility gear assembly for providing users with a compact sheath-cord combination 10 essentially comprising a blade-protecting sheath as at 11 and an ornamentally or decoratively braided length of cord as at 12. The ornamentally braided cord 12 is attached or fastened to the sheath 11 in a unique manner. Before being braided, the cord 12 is typically provided in various cord lengths 15 as specified by the user.

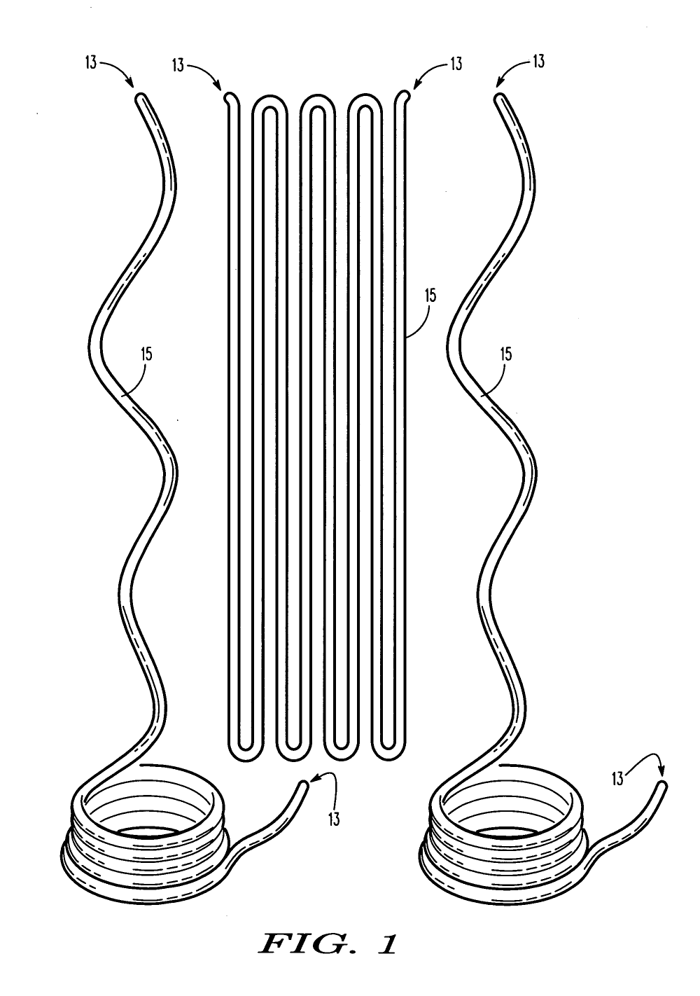

From a comparative inspection of FIG. 1-3, the reader may note that the unbraided cord lengths 15 may be assembled such that an inner folded cord length 16 may be enveloped by an outer braided cord length 17, and together the length 16 and the length 17 may cooperably yield the ornamentally braided length of cord as at 12. The essential notion being addressed is to maximize the overall length of cord otherwise fastenable or outfittable upon the sheath 11 for exemplary use in outdoor or survival type scenarios.

The preferred material construction of the cord 12 is that of so-called parachute cord otherwise known as paracord or 550 cord, which cord typically has a nylon or polymeric component. In this regard, it is noted that a key feature of the cord 12 (regardless of brand name or provider) is that it preferably comprises thermally-liquefiable material, which material once liquefied into a globule, may be re-solidified into an irregularly shaped globular anchor 14 to “weld” or anchor the cord ends 13 of the cord 12 to the sheath 11.

Notably, “nylon” is a generic designation for a family of synthetic polymeric materials known generically as polyamides first produced on in the 1930's by Wallace Carothers of E.I. du Pont de Nemours and Company (DuPont). As used in this application, the essential feature of the material is its thermoplastic attributes. In other words, a key aspect of the cord 12 is that the polymeric material liquefies when heated (i.e. thermally energized as at 100) and freezes to a hardened state when cooled (i.e. thermally de-energized as at 101) sufficiently.

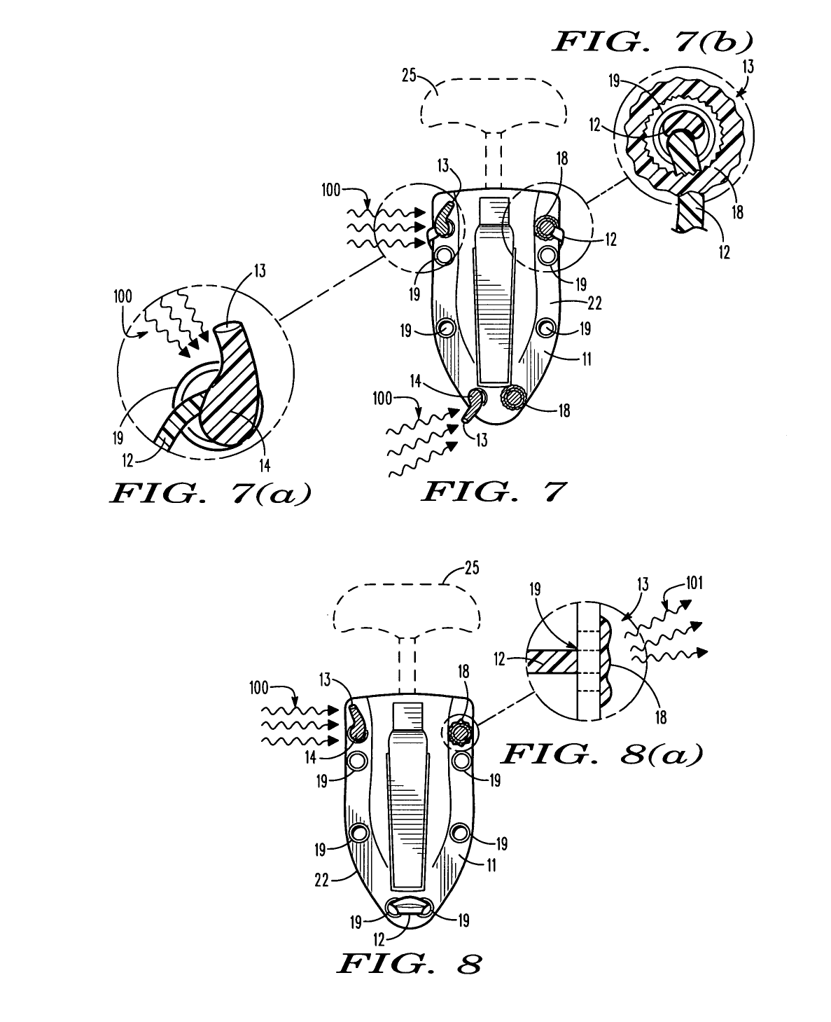

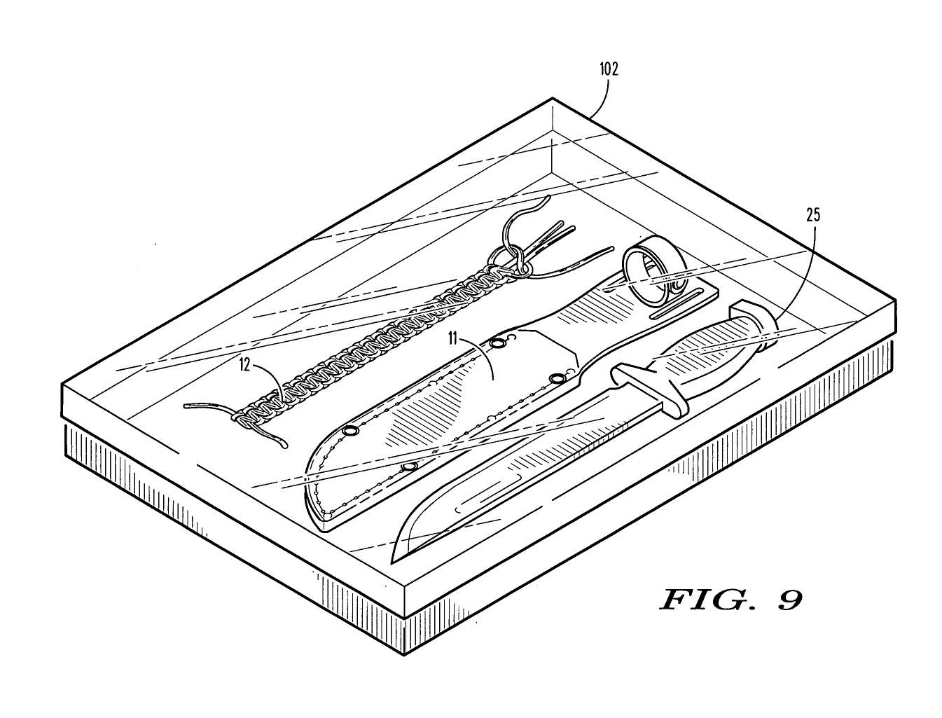

FIG. 7(a) attempts to depict the cord end 13 being softened into a liquefied globular state as at 14. FIG. 7(b) and 8(a) attempt to depict the hardened, frozen, or solidified anchor 18, which anchor 18 comprises a width or diameter sufficient to anchor the cord end 13 to the sheath 11 via the aperture structure formed therein. In this regard, FIG. 7(b) and 8(a) depict apertures as at 19 formed in the sheath 11 adjacent the blade-receiving pocket 20, which apertures 19 extend through forward sheath portion 21 and rearward sheath portion 22.

It is contemplated that the sheath 11 may be formed from either flexible or rigid materials and that the cord 12 may be severed from the sheath 11 with a bladed element as at 25, which bladed element 25 may otherwise be received in the pocket 20 and form part of the sheath-cord combination utility gear assembly or kit.

While the above description contains much specificity, this specificity should not be construed as limitations on the scope of the invention, but rather as an exemplification of the invention. For example, it is contemplated that the present invention essentially provides a sheath-cord combination or assembly comprising a sheath or sheath assembly as at 11 and a length of cord as at 15 or 12.

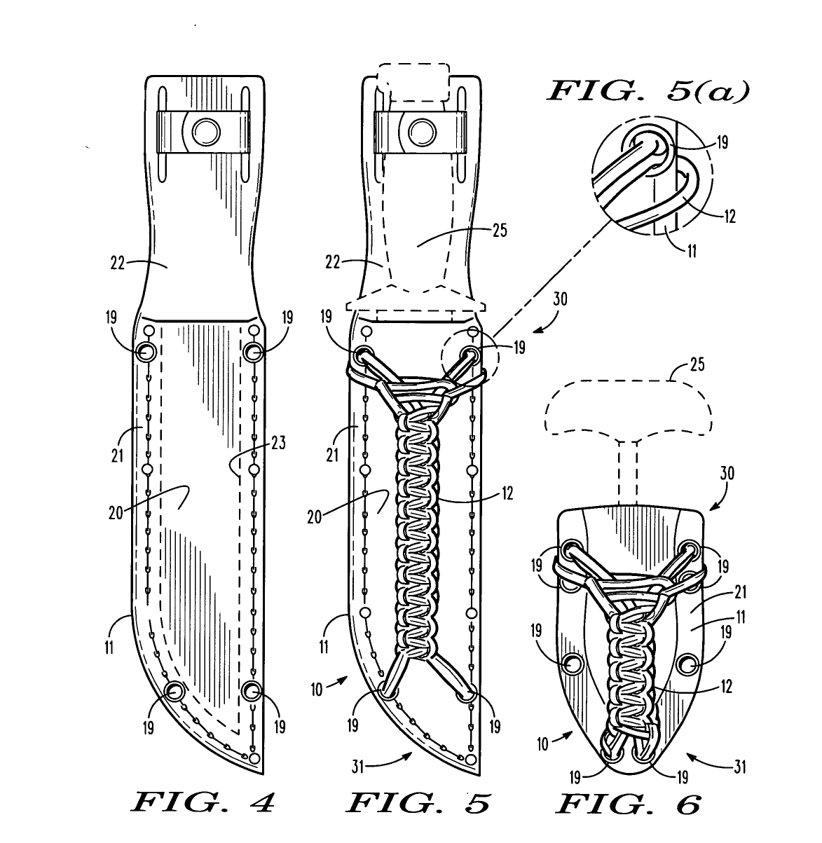

The sheath assembly 11 preferably comprises forward and rearward sheath portions as at 21 and 22, which portions 21 and 22 define a blade-receiving inner pocket as at 20. From an inspection of FIG. 4, it will be seen that the inner pocket 20 has a pocket periphery as referenced at 23. The forward and rearward sheath portions 21 and 22 comprise at least one aperture structure as exemplified by apertures 19, which aperture structure extends through the sheath portions 21 and 22 adjacent the pocket periphery 23.

The length of cord 12 or 15 is preferably constructed from or comprises thermally-liquefiable material and has opposed primary cord ends as at 13. The primary cord ends 13 are insertable through the aperture structure and are thermally-liquefiable as generically depicted in FIGS. 7, 7(a), and 8 for respectively liquefying the primary cord ends 13 at the aperture structure. The liquefied primary cord ends as at 14 are thermally-solidifiable as generically depicted in FIG. 8(a) for fastening or anchoring the primary cord ends 13 to the sheath assembly 11 at the aperture structure.

The sheath-cord combination or utility gear assembly may further comprise, in combination, a blade element as at 25, which element 25 is receivable in the blade-receiving pocket 20 intermediate the pocket periphery 23. In this regard, it is contemplated that the sheath-cord combination 10 may well provide users with a blade element 25, a blade-protecting sheath 11 and a severable length of cord 12 or 15, which cord may be severed by way of the bladed element 25.

The sheath assembly 11 may be further described by comprising a blade-receiving first end 30, a blade-stopping second end 31, and a sheath length intermediate said first and sheath second ends 30 and 31. The aperture structure may well comprise at least two pairs of apertures 19, wherein a first pair of apertures 19 are formed adjacent the first sheath end 30, and a second pair of apertures 19 are formed adjacent the second sheath end 31. The length of cord 12 or 15 is thus extendable along the sheath length intermediate the first and second sheath ends 30 and 31 as generally depicted in FIGS. 5 and 6. The length of cord attached, fastened or anchored to the sheath 11 is preferably braided as at 12 so as to maximize the effective length of the cord extendable along the sheath length intermediate the first and second sheath ends 30 and 31.

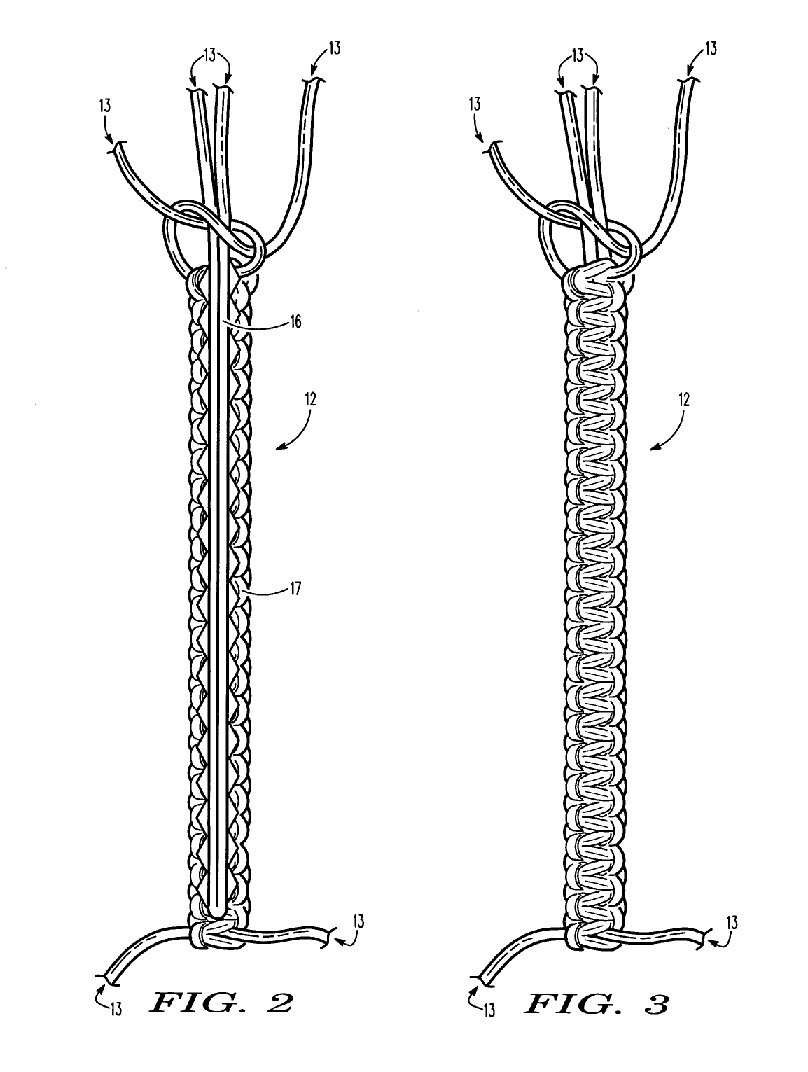

In this regard, it is contemplated that a plurality of cord lengths as generally depicted in FIG. 1 may be interbraided for further maximizing the effective length of cord extendable along the sheath length intermediate the first and second sheath ends. FIG. 2, for example, shows cord 16 enveloped by 17. Given that a number of cord lengths may be provided, it is further contemplated that said lengths may comprise a series of cord ends 13 (e.g. more than two cord ends 13) that are thermally-liquefiable and thermally solidifiable for fastening the plurality of cord lengths to the sheath assembly 11 at the aperture structure.

It is further contemplated that the present invention may be packaged (as at 102) in the form of a utility gear or sheath-cord kit for providing users with a blade-protecting sheath 11 outfittable with a length of cord as at 12 or 15. Still further, the foregoing specifications are believed to support certain methodology for assembling a sheath-cord combination or utility gear assembly. In this last regard, it is contemplated that the method may be said to comprise the steps of forming a sheath and providing a length of cord.

The sheath is formed so as to comprise a blade-receiving inner pocket and at least one aperture structure extending therethrough adjacent the pocket. The length of cord preferably comprises thermally-liquefiable material and has opposed primary cord ends. The primary cord ends are extended through the aperture structure of the sheath whereafter thermal energy may be directed into the primary cord ends for liquefying the thermally-liquefiable material at the primary cord ends. The thermally-liquefied material at the primary cord ends may then be solidified for fastening at least one length of cord to the sheath at the aperture structure.

Accordingly, although the invention has been described by reference to certain preferred and alternative embodiments, and certain methodology, it is not intended that the novel disclosures herein presented be limited thereby, but that modifications thereof are intended to be included as falling within the broad scope and spirit of the foregoing disclosure, the following claims and the appended drawings.

I claim:

1. A sheath-cord assembly for providing users with a blade-protecting sheath and a length of cord, the sheath-cord assembly comprising, in combination:
a sheath assembly, the sheath assembly having forward and rearward sheath portions, the forward and rearward sheath portions defining a blade-receiving inner pocket, the inner pocket having a pocket periphery, the forward and rearward sheath portions comprising at least one aperture structure extending therethrough adjacent the pocket periphery; and
at least one length of cord, the length of cord comprising thermally-liquefiable material and having opposed primary cord ends, the primary cord ends being insertable through the aperture structure and being thermally-liquefiable for respectively liquefying the primary cord ends at the aperture structure, the liquefied primary cord ends being thermally-solidifiable for fastening the primary cord ends to the sheath assembly at the aperture structure, the sheath-cord assembly thus for providing users with a blade-protecting sheath and an end-fastened length of cord.

2. The sheath-cord assembly of claim 1 comprising, in combination, a blade element, the blade element being receivable in the blade-receiving pocket intermediate the pocket periphery, the sheath-cord assembly for providing users with a blade element, a blade-protecting sheath and a severable length of cord, the length of cord being severable via the blade element.

3. The sheath-cord assembly of claim 1 wherein the aperture structure is defined by at least one pair of apertures, the primary cord ends being attachable to the sheath assembly at the pair of apertures.

4. The sheath-cord assembly of claim 3 wherein the sheath assembly comprises a blade-receiving first end, a blade-stopping second end, and a sheath length intermediate said first and second sheath ends, said aperture structure being defined by at least two pairs of apertures, a first pair of apertures being adjacent the first sheath end and a second pair of apertures being adjacent the second sheath end, the length of cord being extendable along the sheath length intermediate the first and second sheath ends.

5. The sheath-cord assembly of claim 4 wherein the length of cord is braided, the braided length of cord for maximizing the effective cord length extendable along the sheath length intermediate the first and second sheath ends.

6. The sheath-cord assembly of claim 5 comprising a plurality of cord lengths, said cord lengths being interbraidable for further maximizing the effective cord length extendable along the sheath length intermediate the first and second sheath ends.

7. The sheath-cord assembly of claim 6 wherein the plurality of cord lengths comprise a series of cord ends, the series of cord ends being thermally-liquefiable and thermally solidifiable for fastening the plurality of cord lengths to the sheath assembly at the aperture structure.

8. A sheath-cord kit for providing users with a blade-protecting sheath outfittable with a length of cord, the sheath-cord kit comprising:
a sheath assembly, the sheath assembly having forward and rearward sheath portions, the forward and rearward sheath portions defining a blade-receiving inner pocket, the inner pocket having a pocket periphery, the forward and rearward sheath portions comprising at least one aperture structure extending therethrough adjacent the pocket periphery; and
at least one length of cord, the length of cord comprising thermally-liquefiable material and having opposed primary cord ends, the primary cord ends being insertable through the aperture structure and being thermally-liquefiable for respectively liquefying the primary cord ends at the aperture structure, the liquefied primary cord ends being thermally-solidifiable for fastening the primary cord ends to the sheath assembly at the aperture structure, the length of cord thus being outfittable upon the sheath assembly for providing users with a blade-protecting sheath and end-fastened length of cord.

9. The sheath-cord kit of claim 8 comprising a bladed element, the bladed element being receivable in the blade-receiving pocket intermediate the pocket periphery, the sheath-cord kit thus for providing users with a blade element, a blade-protecting sheath and a severable length of cord, the length of cord being severable via the blade element.

10. The sheath-cord kit of claim 8 wherein the aperture structure is defined by at least one pair of apertures, the cord ends being attachable to the sheath assembly at the pair of apertures.

11. The sheath-cord kit of claim 10 wherein the sheath assembly comprises a blade-receiving first sheath end, a blade-stopping second sheath end, and a sheath length intermediate said first and second sheath ends, said aperture structure being defined by at least two pairs of apertures, a first pair of apertures being adjacent the first sheath end and a second pair of apertures being adjacent the second sheath end, the length of cord being extendable along the sheath length intermediate the first and second sheath ends.

12. The sheath-cord kit of claim 11 wherein the length of cord is braided, the braided length of cord for maximizing the effective cord length extendable along the sheath length intermediate the first and second sheath ends.

13. The sheath-cord kit of claim 12 comprising a plurality of cord lengths, said cord lengths being interbraidable for further maximizing the effective cord length extendable along the sheath length intermediate the first and second sheath ends.

14. The sheath-cord kit of claim 13 wherein the plurality of cord lengths comprise a series of cord ends, the series of cord ends being thermally-liquefiable and thermally solidifiable for fastening the plurality of cord lengths to the sheath assembly at the aperture structure.

15. A method for assembling a sheath-cord combination, said method comprising the steps of:
forming a sheath with a blade-receiving inner pocket and at least one aperture structure extending therethrough adjacent the pocket;
providing at least one length of cord, the length of cord comprising thermally-liquefiable material and having opposed primary cord ends;
extending the primary cord ends through the aperture structure of the sheath;
directing thermal energy into the primary cord ends thereby liquefying the thermally-liquefiable material at the primary cord ends; and
solidifying the thermally-liquefied material at the primary cord ends thereby fastening at least one length of cord to the sheath at the aperture structure.

16. The method of claim 15 wherein at least one length of cord is braided before extending the primary cord ends through the aperture structure of the sheath.

17. The method of claim 16 wherein at least one outer braided length of cord envelopes at least one inner length of cord before extending the primary cord ends through the aperture structure of the sheath.

18. The method of claim 17 wherein the aperture structure comprises at least one pair of opposed apertures, the cord ends being attachable to the sheath assembly via the pair of opposed apertures.

19. The method of claim 18 wherein the sheath comprises a blade-receiving first sheath end, a blade-stopping second sheath end, and a sheath length intermediate said first and second sheath ends, said aperture structure being defined by at least two pairs of apertures, a first pair of apertures being adjacent the first sheath end and a second pair of apertures being adjacent the second sheath end, the length of cord being extended along the sheath length intermediate the first and second sheath ends before extending the primary cord ends through the aperture structure of the sheath.

20. The method of claim 15 whereby the step of providing at least one length of cord is defined by providing a plurality of cord lengths, the plurality of cord lengths comprising a series of cord ends, the series of cord ends being thermally-liquefiable and thermally solidifiable for fastening the plurality of cord lengths to the sheath assembly at the aperture structure.
